(19) United States
(12) Patent Application Publication
(10) Pub. No.: US 2021/0393009 A1
(43) Pub. Date: Dec. 23, 2021

(54) LUNCHBOX

(71) Applicants: CS CENTRO STIRLING, S.COOP., Aretxabaleta (ES); SILICONAS SILAM S.A., Zumaia (ES); AGRUPACION CLUSTER DE ELECTRODOMESTICOS DE EUSKADI A.I.E, Arrasate - Mondragon (ES)

(72) Inventors: Francisco Javier ARANCETA AGUIRRE, Aretxabaleta (ES); Juan Antonio GARATE ALDAZ, Zumaia (ES); Xabier GORRITXATEGI RETOLAZA, Arrasate - Mondragon (ES)

(21) Appl. No.: 17/466,467

(22) Filed: Sep. 3, 2021

Related U.S. Application Data
(63) Continuation of application No. PCT/ES2020/070123, filed on Feb. 20, 2020.

(30) Foreign Application Priority Data
Mar. 5, 2019 (EP) 19382167.5

(51) Int. Cl. A45C 11/20; A45C 15/00; H05B 3/34; H05B 1/02

(52) U.S. Cl. CPC A45C 11/20; A45C 15/00; H05B 3/34; H05B 2203/017; H05B 1/0222; H05B 2203/013; H05B 1/0261

(57) ABSTRACT

A lunchbox that includes a container for storing food and a closure lid for closing the container, the closure lid including an electrical heater and a switch that is configured to clos to allow the passage of an electric current toward the electrical heater when the food in the container is supported on the closure lid.

### CROSS-REFERENCE TO RELATED APPLICATIONS

The present application relates to and claims the benefit and priority to International Application No. PCT/ES2020/070123, filed Feb. 20, 2020, which claims the benefit and priority to European Patent Application NO. 19382167.5, filed Mar. 5, 2019.

### TECHNICAL FIELD

The present invention relates to lunchboxes comprising a container for food and a closure lid for closing the container in a leak-tight manner.

### BACKGROUND

Lunchboxes comprising a container for food and a closure lid for closing the container in a leak-tight manner are known. Lunchboxes incorporating heating means for heating the food before consuming it are also known.

US2017/0137205A1 describes a lunchbox comprising a container for food and a closure lid for closing the container in a leak-tight manner. The lunchbox comprises electrical heating means in the container and may also comprise electrical heating means in the closure lid.

### SUMMARY

According to one embodiment a lunchbox is provided that comprises a container for food and a closure lid for closing the container in a leak-tight manner. The closure lid comprises an electrical heating means and also comprises switching means that closes to allow the passage of an electric current toward the electrical heating assembly when the food in the container is supported on the closure lid.

Provided is a new concept of a lunchbox in which the user has to turn the lunchbox upside down, supporting it on the closure lid, in order to heat the food included in the lunchbox. In this position, with the food being supported on the closure lid of the lunchbox, the passage of an electric current to the electrical heating means of the closure lid is allowed and heating of the food occurs.

These and other advantages and features will become evident in view of the drawings and detailed description.

### BRIEF DESCRIPTION OF THE DRAWINGS

FIG. 1 shows a cross-section view of a closure lid of a lunchbox according to one embodiment.

FIG. 2 shows a cross-section view of the closure lid of FIG. 1 closing the container of the lunchbox, with the lunchbox being supported on the container.

FIG. 3 shows a cross-section view of the lunchbox of FIG. 2, with the lunchbox being supported on the closure lid.

FIG. 4 shows an exploded view of the electrical heating means and the switching means of the closure lid of FIG. 1.

FIG. 5 shows an electrical diagram of the closure lid of FIG. 1.

### DETAILED DESCRIPTION

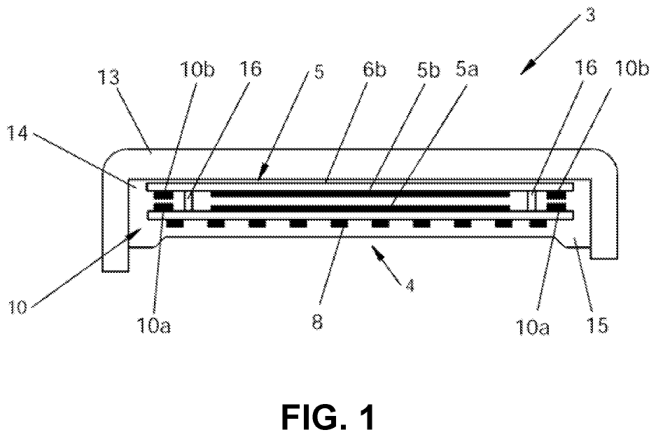

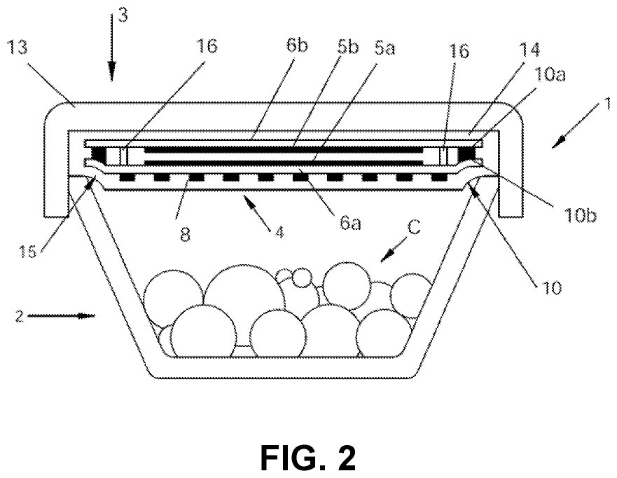

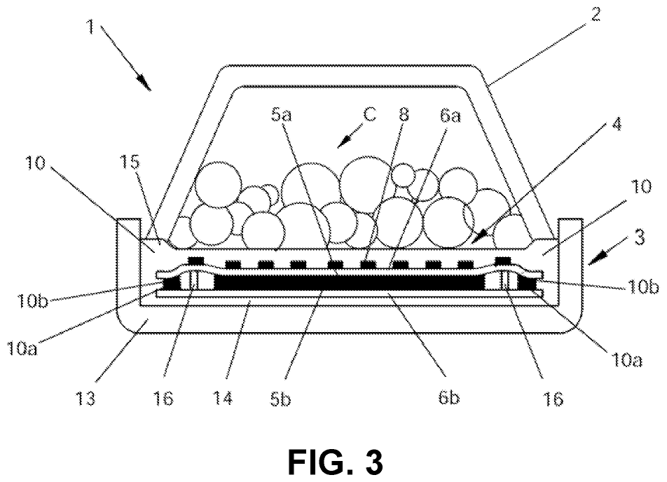

As shown in FIG. 2, the lunchbox of the invention comprises a container 2 for food C and a closure lid 3 for closing the container 2 in a leak-tight manner. The closure lid 3 comprises electrical heating means 4. The closure lid 3, shown in FIG. 1, comprises switching means 5 which when closed allows the passage of an electric current toward the heating means 4 when the food C in the container 2 is supported on the closure lid 3, as shown in FIG. 3.

In a preferred embodiment, the switching means 5 is configured for being closed as a result of the weight of the food C in the container 2 on the closure lid 3, like in the case of the embodiment shown in the drawings. The switching means 5 preferably comprise at least two opposite conductive elements 5a and 5b which by default are separated from one another and which are configured to allow the passage of the electric current toward the heating means 4 when the weight of the food C in the container 2 acts on one of the conductive elements 5a, moving it until contacting the other conductive element 5b.

In a preferred embodiment, as shown in FIG. 2 the switching means 5 comprise two flexible sheets 6a and 6b arranged longitudinally in the closure lid 3, the flexible sheet 6a comprising the conductive element 5a and the flexible sheet 6b comprising the conductive element 5b. The conductive elements 5a and 5b are preferably conducting surfaces arranged on opposite faces of the flexible sheets 6a and 6b.

The flexible sheets 6a and 6b are separated by stops 16 arranged in this embodiment in the flexible sheet 6b. When the lunchbox 1 is placed upside down and the food C rests on the closure lid 3, the flexible sheet 6a bends as a result of the weight of the food C and the conductive element 5a contacts the conductive element 5b, as seen in FIG. 3. When the lunchbox 1 is placed back in its normal position, the flexible sheet 6a is again separated from the flexible sheet 6b.

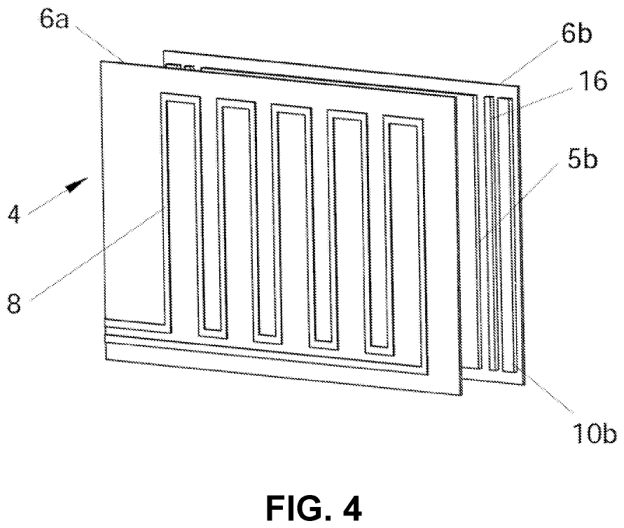

The heating means 4 preferably comprise a heating resistor 8 which is in contact with one of the flexible sheets 6a or 6b of the switching means 5. In a preferred embodiment, the heating resistor 8 is screen-printed on one of the flexible sheets 6a or 6b of the switching means 5, as shown in FIG. 4, preferably on the face of the flexible sheet 6a which is opposite the inside of the container 2.

In a preferred embodiment, the closure lid 3 comprises a rigid casing 13, preferably made of plastic. The switching means 5 is arranged on an inner face of the rigid casing 13, the switching means 5 preferably being covered with a layer 14 of food-grade silicone. In a preferred embodiment, the switching means 5 is embedded in the layer 14 of food-grade silicone.

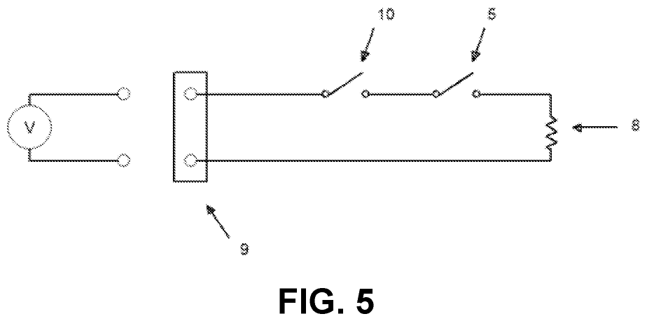

In a preferred embodiment, the lunchbox 1 also comprises safety switching means 10 arranged in series with the switching means 5 of the closure lid 3, the safety switching means 10 being configured to allow the passage of an electric current when the lunchbox 1 is closed. FIG. 5 shows the electric circuit corresponding to this embodiment. In this way, the heating means 4 are only powered if the lunchbox 1 is closed, preventing the heating means 4 from heating up when the closure lid 3 is separated from the container 2.

The safety switching means 10 preferably comprise at least two opposite conductive elements 10a and 10b which by default are separated from one another, as shown in FIG. 1, and which are configured to allow the passage of an electric current toward the heating means 4 when the container 2 pushes one of the conductive elements 10a upon closing the lunchbox 1, moving the conductive element 10a until contacting the other conductive element 10b, as shown in FIG. 2.

In a preferred embodiment, the switching means 5 and the safety switching means 10 are embedded in the same layer 14 of food-grade silicone, the layer 14 comprising a perimetral seal 15 for closing the container 2 in a leak-tight manner. Furthermore, in a preferred embodiment the conductive elements 10a and 10b are conducting surfaces arranged on opposite faces of the flexible sheets 6a and 6b, as shown in FIGS. 1 to 3.

The closure lid 3 preferably comprises a connector 9, not shown in FIGS. 1 to 4, configured for being connected to an external power source, the switching means 5 being arranged between the connector 9 and the heating means 4. In the embodiment shown in the drawings, the switching means 5 and the safety switching means 10 are arranged in series between the connector 9 and the heating means 4, as shown in FIG. 5.

The invention also relates to a closure lid 3 like the one described which can be used with different conventional containers 2 insofar as the closure lid 3 and the container 2 have the suitable shape and dimensions for them to fit together, such that the container 2 is closed in a leak-tight manner. The closure lid 3 is therefore an accessory which converts conventional containers 2 into containers in which food can be heated.

The clauses that follow disclose additional embodiments.

Clause 1. A lunchbox comprising a container (2) for food (C) and a closure lid (3) for closing the container (2) in a leak-tight manner, the closure lid (3) comprising electrical heating means (4), the closure lid (3) comprising switching means that closes to allow the passage of an electric current toward the heating means (4) when the food (C) in the container (2) is supported on the closure lid (3).

Clause 2. The lunchbox according to clause 1, wherein the switching means (5) are configured for being closed as a result of the weight of the food (C) in the container (2) on the closure lid (3).

Clause 3. The lunchbox according to clause 2, wherein the switching means (5) comprise at least two opposite conductive elements (5a, 5b) which by default are separated from one another and which are configured to allow the passage of the electric current toward the heating means (4) when the weight of the food (C) in the container (2) acts on one of the conductive elements (5a), moving it until contacting the other conductive element (5b).

Clause 4. The lunchbox according to clause 3, wherein the switching means (5) comprise two flexible sheets (6a, 6b) arranged longitudinally in the closure lid (3), each flexible sheet (6a, 6b) comprising one of the conductive elements (5a, 5b).

Clause 5. The lunchbox according to clause 4, wherein the conductive elements (5a, 5b) are conducting surfaces arranged on opposite faces of the flexible sheets (6a, 6b).

Clause 6. The lunchbox according to clause 4 or 5, wherein the heating means (4) comprise a heating resistor (8) which is in contact with one of the flexible sheets (6a, 6b) of the switching means (5).

Clause 7. The lunchbox according to clause 6, wherein the heating resistor (8) is screen-printed on one of the flexible sheets (6a, 6b) of the switching means (5).

Clause 8. The lunchbox according to any of the preceding clauses, wherein the closure lid (3) comprises a rigid casing (13), preferably made of plastic, the switching means (5) being arranged on an inner face of the rigid casing (13), and the switching means (5) being covered with a layer (14) of food-grade silicone.

Clause 9. The lunchbox according to clause 8, wherein the switching means (5) are embedded in the layer (14) of food-grade silicone.

Clause 10. The lunchbox according to any of the preceding clauses, comprising safety switching means (10) arranged in series with the switching means (5) of the closure lid (3), the safety switching means (10) being configured to allow the passage of an electric current when the lunchbox (1) is closed.

Clause 11. The lunchbox according to clause 10, wherein the safety switching means (10) comprise at least two opposite conductive elements (10a, 10b) which by default are separated from one another and which are configured to allow the passage of an electric current toward the heating means (4) when the container (2) pushes one of the conductive elements (10a) upon closing the lunchbox (1), moving the conductive element (10a) until contacting the other conductive element (10b).

Clause 12. The lunchbox according to clause 10 or 11, wherein the switching means (5) and the safety switching means (10) are embedded in one and the same layer (14) of food-grade silicone, the layer (14) comprising a perimetral seal (15) for closing the container (2) in a leak-tight manner.

Clause 13. The lunchbox according to any of the preceding clauses, wherein the closure lid (3) comprises a connector (9) configured for being connected to an external power source, the switching means (5) being arranged between the connector (9) and the heating means (4).

Clause 14. A closure lid of a lunchbox (1) according to any of the preceding clauses.

What is claimed is:

1. A lunchbox comprising:
a container for storing a food item; and
a closure lid configured to close the container, the closure lid including an electrical heater that is operatively coupled to a switch, the switch configured to transition between an open position and a closed position, when in the open position the switch prevents electrical current to be delivered to the electrical heater, when in the closed position the switch allows electrical current to be delivered to the electrical heater to energize the electrical heater to cause a heating of the food item, the switch being continuously biased towards the open position and configured to transition from the open position to the closed position upon a weight of the food item acting on the switch.

2. The lunchbox according to claim 1, having an upright position and an upside down position, in the upright position the lunchbox is configured to be supported on the container, in the upside down position the lunchbox is configured to be supported on the closure lid, the switch being configured to be acted on by the weight of the food item when the lunchbox is in the upside down position.

3. The lunchbox according to claim 1, wherein the closure lid is configured to close the container in a leak-tight manner

4. The lunchbox according to claim 1, wherein the switch includes a first conductive element and a second conductive element, the first and second conductive elements arranged spaced-apart and facing one another while being continuously biased away from one another, the switch being in the open position when the first and second conductive elements are spaced-apart from one another, the switch being in the closed position when the first and second conductive elements contact one another.

5. The lunchbox according to claim 4, wherein the first conductive element is moveable towards the second conductive element upon the weight of the food item acting on the first conductive element.

6. The lunchbox according to claim 4, wherein the switch includes a first flexible sheet having a first face and a second flexible sheet having a second face, the first and second faces arranged facing one another, the first and second flexible sheets respectively comprising the first and second conductive elements.

7. The lunchbox according to claim 6, wherein the first conductive element is located on the first face and the second conductive element is located on the second face.

8. The lunchbox according to claim 6, wherein the electrical heater includes a heating resistor that is in contact with one of the first and second flexible sheets.

9. The lunchbox according to claim 8, wherein the heating resistor is screen-printed on the one of the first and second flexible sheets.

10. The lunchbox according to claim 1, wherein the closure lid comprises a rigid casing, the switch being arranged on an inner face of the rigid casing.

11. The lunchbox according to claim 10, wherein the rigid casing is made of a plastic.

12. The lunchbox according to claim 1, wherein the switch is covered with a layer of food-grade silicone.

13. The lunchbox according to claim 1, wherein the switch is embedded in a layer of food-grade silicone.

14. The lunchbox according to claim 1, further comprising a safety switch arranged electrically in series with the switch, the safety switch being configured to allow the passage of an electric current only when the closure lid closes the container.

15. The lunchbox according to claim 14, wherein the safety switch incudes a first conductive element and a second conductive element, the first and second conducive elements arranged facing one another and biased to be spaced-apart from one another when the closure lid is not positioned to close the container, one of the first and second conductive elements being movable to contact the other upon the closure lid closing the container.

16. The lunchbox according to claim 14, wherein the switch and the safety switch are embedded in one and the same layer of a food-grade silicone.

17. The lunchbox according to claim 16, wherein the layer of a food-grade silicone comprises a perimetral seal for closing the container in a leak-tight manner.

18. The lunchbox according to claim 1, wherein the closure lid comprises an electrical connector configured to be connected to an external power source, the switch being arranged electrically between the connector and the electrical heater.

19. A closure lid for closing a food storage container, the closure lid comprising an electrical heater that is operatively coupled to a switch, the switch configured to transition between an open position and a closed position, when in the open position the switch prevents electrical current to be delivered to the electrical heater, when in the closed position the switch allows electrical current to be delivered to the electrical heater to energize the electrical heater to cause a heating of the food item, the switch being continuously biased towards the open position and configured to transition from the open position to the closed position upon the weight of food acting on the switch.

20. The closure lid according to claim 19, wherein the switch includes a first conductive element and a second conductive element, the first and second conductive elements arranged spaced-apart and facing one another while being continuously biased away from one another, the switch being in the open position when the first and second conductive elements are spaced-apart from one another, the switch being in the closed position when the first and second conductive elements contact one another, the switch including a first flexible sheet having a first face and a second flexible sheet having a second face, the first and second faces arranged facing one another, the first and second flexible sheets respectively comprising the first and second conductive elements.
